(19) United States
(12) Patent Application Publication
(10) Pub. No.: US 2025/0086396 A1
(43) Pub. Date: Mar. 13, 2025

(54) TEXT PROCESSING METHOD AND RELATED APPARATUS

(71) Applicant: Mashang Consumer Finance Co., Ltd., Chongqing (CN)

(72) Inventor: Changlin LI, Chongqing (CN)

(73) Assignee: Mashang Consumer Finance Co., Ltd., Chongqing (CN)

(21) Appl. No.: 18/826,226

(22) Filed: Sep. 6, 2024

(30) Foreign Application Priority Data
Sep. 8, 2023 (CN) 202311163712.0

(51) Int. Cl. G06F 40/30

(52) U.S. Cl. CPC G06F 40/30

(57) ABSTRACT

An embodiment of the present application provides a text processing method and apparatus, where the text processing method includes: obtaining N texts and calculating a text distance between every two texts, to obtain a text set, where the text set includes M text pairs and the text distance between the two texts of each text pair; constructing a text relation map based on the text set including the text node and the connection edge between two text nodes, where the weight of the connection edge reflects a text distance between the texts corresponding to the two text nodes; and determining a text similarity between the two texts in the non-associated text pair in the text relation map according to a path between the non-associated text pairs, where the non-associated text pair is a text pair with a text distance greater than a preset threshold value.

### CROSS-REFERENCE TO RELATED APPLICATION

This application claims the benefit of priority of Chinese Patent Application No. 202311163712.0, filed on Sep. 8, 2023, the contents of which are incorporated by reference as if fully set forth herein in their entirety.

### TECHNICAL FIELD

The present application relates to a technical field of data processing, and more particularly, to a text processing method and a related apparatus.

### BACKGROUND

With the continuous development and progress of the Internet and information technology, more and more services are carried out through the Internet, more and more information is transmitted through the Internet, and more and more texts are transmitted through the Internet. The calculation of the similarity of the text on the Internet is an important link in natural language processing, and may be used in various tasks such as text classification, information retrieval, and cluster analysis. The similarity of the text is to compare the similarity between two texts, and how to calculate the similarity between the two texts accurately and efficiently is the focus of increasing attention of text providers and text processing methods.

### SUMMARY

In a first aspect, an embodiment of the present disclosure provides a text processing method, which includes: calculating a distance between every two ones of texts, to obtain a text set, wherein the text set comprises every two ones of texts and the distance between every two ones of texts; constructing a text relation map based on the text set, wherein the text relation map comprises text nodes and a connection edge between the text nodes and a weight of the connection edge reflects the text distance between the texts respectively corresponding to two ones of the text nodes connected through the connection edge; and in response to the distance between two ones of the texts greater than a preset threshold value, determining a text similarity between the two ones of the texts according to a path between two of the nodes corresponding to the two ones of the texts, wherein the path comprises at least two of the connected edges.

In an embodiment of the present application, in a process of performing text processing, for N texts, a text distance between every two texts is calculated to obtain a text set including M text pairs and the text distance between the two texts of each text pair. A text relation map formed by a text node and a connection edge for the text nodes is constructed based on the text set. Whereby the text set is obtained by directly calculating the text distance. A text relation map is constructed by the text set, and the text relation map includes a text node and a connecting edge with a weight reflecting a text distance between the texts respectively corresponding to the two nodes connected through the connecting edge, thereby improving a representation effect of a relationship between every two texts in the constructed text relation map. Further, a text similarity between the two texts in the non-associated text pair in the text relation map is determined according to a path between the two nodes corresponding to two of the texts in the non-associated text pairs. The text similarity between the two texts in the non-associated text pair in the text relation map is calculated through the path between the non-associated text pairs. Since the path between the two nodes corresponding to two of the texts in the non-associated text pair in the text relation map may reflect the distance relationship between the two texts in the non-associated text pair more accurately and comprehensively, the text similarity calculated by this method is more accurate.

In a second aspect, an embodiment of the present disclosure provides a text processing apparatus, which includes: an obtaining module configured to calculate a distance between every two ones of texts, to obtain a text set, wherein the text set comprises every two ones of texts and the distance between every two ones of texts; a construction module configured to construct a text relation map based on the text set, wherein the text relation map comprises nodes and connection edges, each of the nodes corresponds to a corresponding one of the texts, at least two ones of the nodes are connected via the connection edge, and a weight of each of the connection edges corresponds to the distance between two of the texts corresponding to two of the nodes connected through the connected edge; and a determining module configured to determine a text similarity between the two ones of the texts according to a path between two of the nodes corresponding to the two ones of the texts, in response to the distance between two ones of the texts greater than a preset threshold value, wherein the path comprises at least two of the connected edges.

In a third aspect, an embodiment of the present application provides a text processing device, comprising: a processor and a memory configured to store a computer-executable instruction that, when executed, makes the processor perform the text processing method of the first aspect.

In a fourth aspect, an embodiment of the present application provides a computer-readable storage medium, where the computer-readable storage medium is configured to store a computer-executable instruction, and when executed by a processor, the computer-executable instructions implement the text processing method of the second aspect.

### BRIEF DESCRIPTION OF THE DRAWINGS

In order to more clearly illustrate technical solutions in embodiments of the present application or the prior art, reference will now be made to the accompanying drawings required for the description of the embodiments or the prior art. It will be apparent that the accompanying drawings in the following description are merely some of the embodiments described in this specification, and that other drawings may be obtained from these drawings by those of ordinary skill in the art without exerting creative efforts.

FIG. 1 is a schematic diagram of an implementation environment of a text processing method according to an embodiment of the present application;

FIG. 2 is a processing flowchart of a text processing method according to an embodiment of the present application;

FIG. 3 is a schematic diagram of a text relation map according to an embodiment of the present application;

FIG. 4 is a processing flowchart of a text processing method applied to a semantic matching scene according to an embodiment of the present application;

FIG. 5 is a schematic diagram of a text processing apparatus according to an embodiment of the present application; and

FIG. 6 is a schematic block diagram of a text processing device according to an embodiment of the present application.

### DETAILED DESCRIPTION

To better understand technical solutions in embodiments of the present application by a person of ordinary skill in the art, the technical solutions in the embodiments of the present application will be clearly and completely described with reference to the accompanying drawings in the embodiments of the present application. Apparently, the described embodiments are merely a part of the description of the present application, rather than all the embodiments of the present application. Based on the embodiments of the present application, all other embodiments obtained by a person of ordinary skill in the art without involving any inventive effort shall fall within the scope of the present application.

The calculation of the similarity of the text is an important issue in natural language processing. The similarity is to compare the similarity between two objects, generally by calculating a distance between features of the texts. If the distance is less, the similarity is greater. If the distance is greater, the similarity is less. Many applications in the industry have the requirement to measure a text similarity semantically, which is generally referred to as semantic matching.

Conventional text semantic matching techniques include algorithms such as TF-IDF (Term Frequency-Inverse Document Frequency), Jaccard (Jaccard similarity coefficient is an index to measure the similarity between data), or edit distance, which mainly solve the issue of the matching in lexical level or the semantic similarity in the lexical level. In practice, vocabulary-based matching algorithms have significant limitations. For example, “driver” and “chauffeur” are not literally similar, actually express the same meaning. Recently, the development of deep learning techniques and the establishment of large-scale data sets have brought new development opportunities for text semantic matching. The following are currently more advanced algorithms for semantic matching computation: bert embedding vectors, GPT-3 model, or a text sentence vector representation method such as glove and simcse. bert is one of the most advanced natural language processing techniques at present, which learns context information of sentences from a large-scale corpus by pre-training and expresses the results of the learning as vectors. These vectors may be used to calculate the similarity between two sentences with high accuracy. The GPT-3 model is a language model based on deep learning and has a very strong generating capability. In the latest version, the GPT-3 model already can calculate sentence similarity, and may be pre-trained on large-scale data sets to generate high-quality sentence vectors. After obtaining the sentence vector representation of the text, the similarity between the two texts may be calculated by using methods such as Euclidean distance, cosine similarity, or the like.

An example is provided to illustrate the drawbacks of the prior art. Assuming that there is a text data set of one million levels, k samples are selected as k seed points, text clustering is performed on the data set, and k kinds of data sets are obtained after the text clustering has been performed. It is assumed that there are 100,000 pieces of data in one of the kinds of data sets, from which it is necessary to select 1000 pieces of data that are most similar to the seed points of the kind. In the prior art, the seed points and the 100,000 texts are performed by a text vector representation, the similarities between the seed points and the 100,000 texts are calculated by using methods such as Euclidean distance and cosine similarity and arranged in the order from less to greater, and then the first 1000 texts with the less distance is selected as the 1000 texts most similar to the seed points of the kind. However, this is problematic. For example, it can be found that the 10th text is more similar to the seed points of the kind than the 20th text, and the 100th text is more similar to the seed points of the kind than the 200th text, which is logically in conformity with the logic that the less the distance the more similar the text is. However, it can also be found that the 900th text is more similar to the seed points of the kind than the 800th text, or at least one of the first 1000 texts is more similar to the seed points of the kind than at least one texts after the first 1000 texts, which is contrary to the logic that the less the distance the more similar the text is. The reason is that in the case that the similarity between two texts is calculated by using methods such as Euclidean distance and cosine similarity, the similarity is accurate under the condition that the distance between the texts is less, and the above-mentioned defects occur under the condition that the distance between the texts is greater.

To accurately perform the semantic matching, that is, the calculation of the similarity between the texts, an embodiment of the present application provides a text processing method in which a text relation map is constructed by calculating a text distance between every two texts in the texts, and a text similarity between two texts in a non-associated text pair in the text relation map based on a path between the two nodes corresponding to two of the texts in the non-associated text pairs. Specifically, in a process of constructing the text relation map by the text distance between every two texts in the texts, the text distance between every two texts in the texts is first calculated, to obtain a text set including the text pair and the text distance between two texts of the text pair, and then the text relation map is constructed based on the text set. Therefore, the text relation map including a text node and a connection edge reflecting the text distance between the texts of the two nodes of the text nodes connected through the connecting edge is constructed based on the text set, thereby improving a representation effect between the two texts of the constructed text relation map, and then the similarity between the non-associated text pairs is determined by the path between the two nodes corresponding to two of the texts in the non-associated text pairs in the text relation map. Since the path between the two nodes corresponding to two of the texts in the non-associated text pair in the text relation map may reflect the distance relationship between the two texts in the non-associated text pair more accurately and comprehensively, the text similarity calculated by this method is more accurate. Herein, the text distance is also referred to the distance for short.

A text processing method provided in the present application may be executed by a text processing device, which may be a terminal or a server. The terminal may include a mobile phone, a notebook computer, an in-vehicle terminal, an intelligent wearable device, an intelligent interactive device, or the like. The server may be a separate physical server, a server cluster of a plurality of servers, or a cloud server capable of cloud computing.

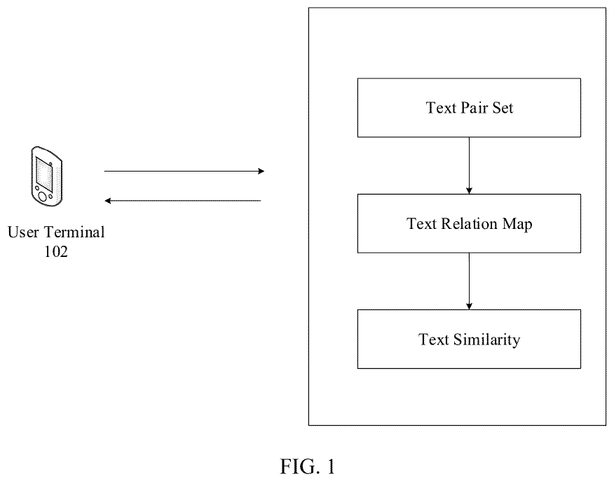

The text processing device being a server is used as an example to describe an application scene of the text processing method of the present application. The text processing method provided in one or more embodiments of the present specification is applicable to an implementation environment for calculating a text similarity between two texts in a text pair. As shown in FIG. 1, the implementation environment includes at least a server 101 for performing text processing. In addition, the implementation environment may further include a user terminal 102 through which a user may collect and submit a text.

The server 101 may be one or more servers, a server cluster composed of several servers, or a cloud server of a cloud computing platform for performing construction of a text relation map (or be referred to text relation graph/image or text relationship graph/image) and calculation of a similar text pair between two texts in a non-associated text pair. The user terminal 102 may be a smartphone, a tablet computer, an electronic book reader, a wearable device, a device for performing information interaction based on an Augmented Reality (AR)/Virtual Reality (VR), or the like. The user terminal 102 is further installed with an application program or a browser through which the user terminal 102 interacts with the user to perform collection and submission of text or voice.

In this implementation environment, after obtaining N text sets, the server 101 first calculates a text distance between every two texts to obtain a text set, constructs a text relation map based on the text set after obtaining the text set, and finally determines a text similarity between the two texts in a non-associated text pair based on a path between the two nodes corresponding to two of the texts in the non-associated text pair in the text relation map, thereby improving the accuracy of the calculated text similarity between the two texts in the non-associated text pair.

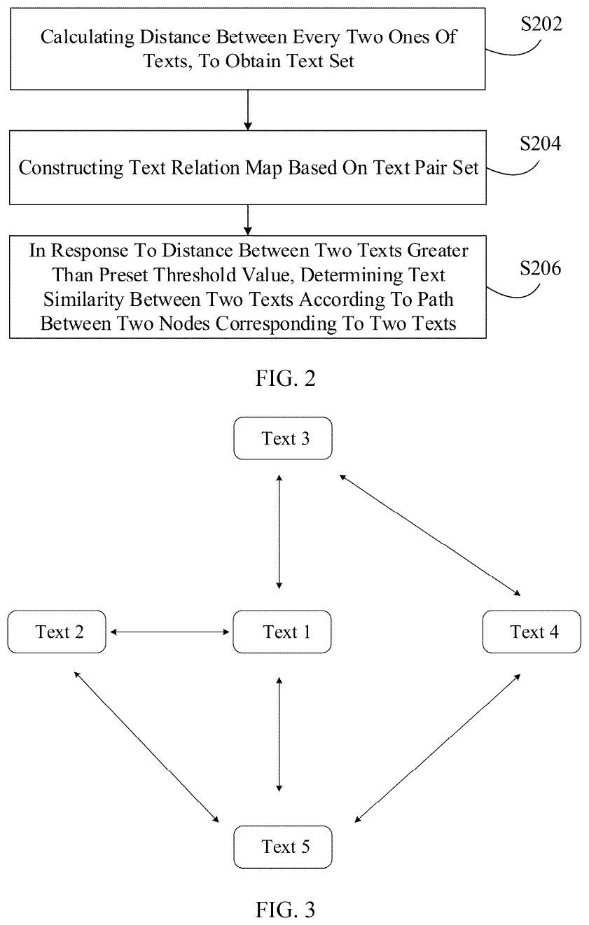

Referring to FIG. 2, FIG. 2 shows a schematic flowchart of a text processing method according to an embodiment of the present application. The text processing method shown in FIG. 2 may be executed by, specifically a processor of, a text processing device. The text processing method shown in FIG. 2 includes Step S202 to Step S206.

At Step S202, a distance between every two ones of N texts is calculated, to obtain a text set, and the text set includes every two ones of texts and the distance between every two ones of texts.

The text in the present embodiment includes a text that needs to be semantic matched and is generated in a semantic matching scene. For example, in conversation scene of a customer service robot, a text obtained after voice conversion is performed on the user voice during a conversation between a customer service robot and a user. After obtaining the text obtained after the voice conversion for the user voice, since the broadcast voice of the customer service robot needs to be determined according to the user's voice, semantic matching needs to be performed on the user voice. In the process of semantic matching the user voice, the user voice and a preset text in a preset text library will be semantically matched. In a condition of a successful match, a reply corresponding to the matched preset text is used as the broadcast voice of the customer service robot. It may be seen that in the conversation scene of the customer service robot, the text corresponding to the user voice and the preset text in the preset text library constitute the N texts in the present embodiment, where N is an integer greater than one.

The text pair in the present embodiment refers to a text pair consisting of any two texts in the texts. Alternatively, the text pair consists of two texts selected among the N texts. To perform semantic matching, the similarity between every two texts in a text set is calculated, and two texts used for calculating the similarity constitute a text pair in the present embodiment. Note that in the present embodiment, the text similarity is characterized by calculating the text distance. The text distance between the two texts in the present embodiment may be a calculated Euclidean distance between the two texts in the text pair, or may be a calculated cosine distance between the two texts in the text pair. The text set in the present embodiment refers to a text set consisting of a text pair of any two texts and a text distance between the two texts in each text pair, and the text distance between the two texts of each text pair is recorded in the text set. Optionally, the text set includes M text pairs and the text distance between two texts of each text pair, where M is greater than or equal to one and less than N.

In specific implementation, after obtaining the N texts, the text distance between every two texts, that is, the text distance between two texts in a text pair consisting of any two texts in the N texts, is first calculated. In an alternative implementation of the present embodiment, the text distance between each two texts is calculated in the following manner:
performing feature encoding on each of the N texts to obtain a feature vector of each of the N texts, and combining any two of the N texts to obtain M text pairs; and
calculating a text distance of the two texts in each text pair in the M text pairs based on the feature vectors of the two texts in each text pair.

In an embodiment, after the N texts are obtained, the feature encoding is performed on each of the N texts to obtain the feature vector of each text, and a text distance between two texts in each text pair is calculated based on the feature vectors of respective texts, thereby improving the convenience and accuracy of calculating the text distance.

Alternatively, in the process of the feature encoding of each text, each text may be input to a feature encoder to perform the feature encoding, so as to obtain the feature vector of each text. Here, the feature encoder may be a word to vector (Word2vec, a correlation model for generating word vectors), or may be bidirectional encoder representations from transformers (BERT), or may be global vectors (GloVe, a word vector model on basis of co-occurrence matrices), or may be another model for performing the feature encoding on the text, which is not limited herein.

Further, after obtaining the M text pairs and the text distance of the two texts in each text pair, the text set including the M text pairs and the text distance between the two texts in each text pair is constructed. Where M=N².

For example, N=4 and four texts include Text 1, Text 2, Text 3, Text 4. Every two texts of the four texts may be semantic matched to obtain the text pair: (Text 1, Text 1), (Text 1, Text 2), (Text 1, Text 3), (Text 1, Text 4), (Text 2, Text 1), (Text 2, Text 2), (Text 2, Text 3), (Text 2, Text 4), (Text 3, Text 1), (Text 3, Text 2), (Text 3, Text 3), (Text 3, Text 4), (Text 4, Text 1), (Text 4, Text 2), (Text 4, Text 3), and (Text 4, Text 4), respectively. The text distance between the two texts in each text pair is calculated. The text set is then constructed based on respective text pairs and the distance between and the two texts in each text pair.

Note that if two texts in the text pair are same, the distance between the two texts in the text pair is 0; If the two texts constituting the text pairs are same in different text pairs, that is, one text pair is (Text 1, Text 2) and another text pair is (Text 2, Text 1), the text distances of these two text pairs are same, that is, a distance between two texts in a text pair is same as a distance between two texts, which are same as the two texts above, in another text pair.

For example, N=n, the text distance between two texts in each text pair is as follows:

| Text | Text 1 | Text 2 | Text 3 | . . . | Text n |
|---|---|---|---|---|---|
| Text 1 | d₁₁ | d₁₂ | d₁₃ | . . . | d₁ₙ |
| Text 2 | d₂₁ | d₂₂ | d₂₃ | . . . | d₂ₙ |
| Text 3 | d₃₁ | d₃₂ | d₃₃ | . . . | d₃ₙ |
| . . . | . . . | . . . | . . . | . . . | . . . |
| Text n | dₙ₁ | dₙ₂ | dₙ₃ | . . . | dₙₙ |

Where dᵢⱼ is the text distance between an i-th text and a j-th text, and if 0<i=j≤n, dᵢⱼ=0; If 0<i≤n, O<j≤n, and i≠j, dᵢⱼ=dⱼᵢ.

At Step S204, a text relation map is constructed based on the text set.

The text relation map refers to a graph representing an association relationship among the respective texts in the N texts. The text relation map is a directed weighted graph, and “directed” refers to a directed connection established between two texts of the associated text pair in the text relation map. “weighted” refers to a weight of a connection edge reflecting a distance between the texts respectively corresponding to two text nodes connected through the connection edge. Alternatively, the text relation map includes the text node and the connection edge between the text nodes. The weight of the connection edge reflects a text distance between the texts respectively corresponding to two text nodes connected through the connection edge.

In specific implementation, in a process of constructing the text relation map based on the text set, the text relation map is constructed based on the text pair and a text distance between the two texts in each text pair. Specifically, an associated text pair and a non-associated text pair are determined in the text pair by the text distance and the preset threshold value, and the text relation map is constructed based on the associated text pair and the non-associated text pair. In other words, the text relation map is constructed based on the associated text pairs and non-associated text pairs in the text set. In an alternative implementation provided by an embodiment of the present application, in the process of constructing the text relation map based on the text set, the following operations are performed.

(1) The associated text pair and the non-associated text pair are determined in the text pairs based on the text distance between every two texts and a preset threshold value.

The associated text pair includes the text pair in which the text distance between the two texts in said text pair is less than or equal to the preset threshold value. The non-associated text pair includes the text pair in which the text distance between the two texts in said text pair is greater than the preset threshold value. Note that the text distance between the two texts is negatively correlated with the text similarity between the two texts.

In a specific execution process, the associated text pair and the non-associated text pair are determined in the text pairs by the text distance between every two texts. The preset threshold value in the present embodiment is determined based on a text screening threshold value of each of the N texts. In an alternative implementation provided in the present embodiment, the preset threshold value is calculated in the following manner:
determining the sub text set for each of the N texts;
calculating the text screening threshold value of each of the N texts based on the sub text set for each of the N texts; and
calculating an average value of the text screening threshold values of respective ones of the texts as the preset threshold value.

Alternatively, the sub text set for each of the N texts consists of the text pairs including each text.

Specifically, the preset threshold value is calculated based on the text screening threshold values of respective ones of the N texts. In the process of calculating the text screening threshold value of each text, the sub text set for each of the texts is first determined, and then the text screening threshold value of each text is calculated based on the sub text set for each of the texts.

In the present embodiment, the text screening threshold value of each text (corresponding to each seed point in the above description) is predetermined determined.

In an alternative implementation provided in this embodiment, the N texts include the i-th text, and i is an integer less than or equal to N. The text screening threshold value of the i-th text is determined as follows:
performing distance representation (and/or cosine similarity representation or the like) on the two texts in each of the text pairs in the sub text set for the i-th text by using the methods in the related art such as Euclidean distance (and/or cosine similarity or the like) method, to obtain text distances (and/or cosine similarity) for the respective text pairs in the sub text set;
arraying the text pairs in the sub text set for the i-th text in a first order based on a size of the text distance (and/or the cosine similarity) for the two texts in each of the text pairs in the sub text set for the i-th text to obtain a text pair list for the i-th text; and
identifying a text pair in the text pair list with the actual similarity ordered in the first order (in the case of the cosine similarity, the actual similarity ordered in a second order opposite to the first order) as a target text pair, and determining a text distance of the target text pair as the text screening threshold of the i-th text.

It will be appreciated that when the text pairs in the text pair list are arrayed in the first order based on the text distance, it is expected that expected similarities of the text pairs will be ordered in the second order. In this case, in an embodiment, the target text pair may be a text pair in the text pair list of which the actual similarity is firstly ordered in the first order in a process of determining the target text pair from the text pairs in the text pair list in the first order. Alternatively, it will be appreciated that when the text pairs in the text pair list are arrayed in the first order based on the cosine similarity, it is expected that expected similarities of the text pairs will be ordered in the first order. In this case, in an embodiment, the target text pair may be a text pair in the text pair list of which the actual similarity is firstly ordered in the second order in a process of determining the target text pair from the text pairs in the text pair list in the first order.

For example, if the text pairs in the sub text set for the i-th text are ordered in an ascending order (that is, the first order) based on the size of the text distance between the two texts in each of the text pairs in the sub text set for the i-th text, the target text pair may be a text pair in the text pair list whose actual similarity is lower than that of another text pair in the text pair list after said text pair.

For example, the sub text set for Text 1 is: {(text 1, text 1), (text 1, text 2), (text 1, text 3), (text 1, text 4), (text 2, text 1), (text 3, text 1), (text 4, text 1)}. Since d₁₁=0, d₁₂=d21, d₁₃=d31, d₁₄=d41, the text screening threshold value of Text 1 may be calculated by using three text pairs (text 1, text 2), (text 1, text 3), and (text 1, text 4). For example, by using the Euclidean distance method in the prior art, the distance representation is performed on the two texts in each of the text pairs in the sub text set for the i-th text, to obtain the text distances: d₁₂=0.3, d₁₃=0.5, d₁₄=0.8, the three text pairs are arrayed in ascending order to obtain a text pair list with a first order of (text 1, text 2), a second order of (text 1, text 3), and a third order of (text 1, text 4). It is expected that the similarities of the text pairs in the text pair list are ordered in descending order opposite to the above ascending order. However, in the prior art, the actual similarity of the text pair (text 1, text 2) is greater than that of the text pair (text 1, text 3), and the actual similarity of the text pair (text 1, text 3) is less than that of the text pair (text 1, text 4). That is, the text pair (text 1, text 3) is the text pair whose the actual similarity is first ordered in the ascending order. The text pair (text 1, text 3) is determined as the target text pair of text 1 and the distance of the text pair (text 1, text 3) is used as the text screening threshold value of text 1 in the embodiment of the present application. For example, text 1 is a word “driver”, text 4 is a word “chauffeur”, and text 3 is a word “passenger”. Even when it is determined that the text distance of the text pair (text 1, text 3) is less than that of the text pair (text 1, text 4) by using the Euclidean distance method, those skilled in the art can determine that the actual similarity of the text pair (text 1, text 3) is less than that of the text pair (text 1, text 4). The text screening threshold value of Text 2, the text screening threshold value of Text 3, and the text screening threshold value of Text 4 are calculated in the above manner, respectively, and then the average value of the text screening threshold values of Text 1, Text 2, Text 3, and Text 4 is calculated as the preset threshold values. Note that the smaller the distance, the higher the similarity. A person skilled in the art can obtain an embodiment for obtaining the text screening threshold based on the method such as the cosine similarity according to the above description based on the Euclidean distance method, and the detailed description is provided herein.

It should be noted that the preset threshold value may be understood as the preset threshold value of the N texts.

In a specific implementation, after calculating the text distance between two texts in each text pair, the associated text pair and the non-associated text pair are determined in the text pairs based on the text distance and the preset threshold value. That is, a text pair of which the text distance between two texts in the text pair is less than the preset threshold value is determined as the associated text pair, and a text pair whose the text distance between two texts in the text pair is greater than or equal to the preset threshold value is determined as the non-associated text pair.

In addition, in addition to calculating the preset threshold value of the N texts, the associated text pair and the non-associated text pair for each text may be screened in accordance with the text screening threshold values of the respective texts. Specifically, after calculating the text screening threshold value of each text, a text pair whose text distance between two texts therein is less than a corresponding text screening threshold value in the sub text set for each text is used as the associated text pair for each text, and a text pair whose text distance between two texts therein is greater than or equal to a corresponding text screening threshold value in the sub text set for each text is used as the non-associated text pair of each text. That is, the associated text pair and the non-associated text pair are determined in the text pairs based on the text distance between every two texts and the preset threshold value. Alternatively, the associated text pair and the non-associated text pair may be determined in the text set based on the text distance and the text screening threshold value of each of the N texts, and a new implementation manner may be provided by combining this step of determining the associated text pair and the non-associated text pair and other processing processes provided in the present embodiment.

(2) The text relation map is constructed from the associated text pair and the non-associated text pair.

Alternatively, there is a directed connection between the text nodes of the associated text pair in the text relation map, and no connection is established between the text nodes of the non-associated text pair.

In a specific implementation, after determining the associated text pair and the non-associated text pair, the text relation map is constructed based on the associated text pair and the non-associated text pair.

As shown in FIG. 3, for example, N=5, by the way described above, the associated text pairs are obtained. The associated text pairs include (Text 1, Text 2), (Text 1, Text 3), (Text 1, Text 5), (Text 2, Text 5), (Text 3, Text 4), and (Text 4, Text 5), and since the distances between the same two texts are same even both of them are in different text pairs, the connection between the two texts in the associated text pair is a two-way arrow connection. The non-associated text pair includes (Text 2, Text 3), (Text 1, Text 4), (Text 3, Text 5), and (Text 2, Text 4), and no connection is established between the two texts in the non-associated text pair.

The weight of the connection edge in the text relation map constructed based on the text set reflects the text distance between the texts respectively corresponding to the two connected nodes. Further, the connection edge may not reflect the text distance between the texts respectively corresponding to the two connected nodes, that is, the constructed text relation map may be merely a directed graph.

In an embodiment, the text processing method further includes: after constructing the text relation map based on the text set, based on the distance between the every two ones of the texts and a preset threshold, processing the text relation map such that two ones of the texts with a distance less than or equal to the preset threshold form a directional connection and two ones of the texts with a distance greater than the predetermined threshold are not connected.

Step S206: in response to the distance between two texts of the N texts greater than a preset threshold value, determining a text similarity between the two texts according to a path between the two nodes corresponding to the two texts, wherein the path comprises at least two of the connected edges. In other words, the text similarity between the two texts in the non-associated text pair in the text relation map is determined according to a path between the two nodes corresponding to two of the texts in the non-associated text pairs.

The path in the present embodiment refers to a connection path between one node corresponding one text to another node corresponding another text in the text relation map. Alternatively, the path includes the connection path between the two nodes corresponding to at least two texts in the directed connection. As shown in FIG. 3, “Text 1↔Text 2” represents a path between Text 1 and Text 2. “Text 1↔Text 3↔Text 4” represents a path between Text 1 and Text 4. Alternatively, the non-associated text pair is a text pair with the text distance greater than the preset threshold value.

In specific implementation, after the text relation map is constructed, the text similarity between the two texts in the non-associated text pair is calculated based on the path the between two texts in the non-associated text pair in the text relation map, that is, the path between the two nodes corresponding to the two texts in the non-associated text pair. In this way, the problem that the distance calculation cannot accurately measure the similarity between the two texts is solved, the shortest distance between the two texts is taken as the true similarity of the two texts, and the accuracy of the text semantic matching is improved. It should be noted that in the present embodiment, the similarity between two texts is characterized by the distance between the two texts. Specifically, the greater the distance, the less the similarity, the greater the similarity, and the less the distance. The above description of the text distance may be replaced with the description of the text similarity, and in the case where the description of the text similarity is replaced, the contents of the description may be adaptively modified in accordance with “the greater the distance, the less the similarity, the greater the similarity, and the less the distance”.

In an alternative implementation provided by an embodiment of the present application, in a process of determining the text similarity between the two texts in the non-associated text pair in the text relation map according to the path between the two nodes corresponding to two of the texts in the non-associated text pair, the following operations are performed:
determining at least one path between two of the nodes corresponding to the two texts in the non-associated text pair based on the text relation map;
calculating a sum of the weights of the connection edges included in each of the at least one path as a similarity of each of the at least one path, to obtain similarities of respective ones of the at least one path; and
determining the text similarity between the two texts in the non-associated text pair based on the similarities of respective ones of the at least one path.

Specifically, the similarity of each of the at least one path between the two nodes corresponding to the two texts in the non-associated text pair is first calculated, and then the text similarity between the two texts in the non-associated text pair is determined according to the similarities of respective ones of the at least one path.

In order to improve the text similarity between the two texts in the obtained non-associated text pair, in an alternative implementation of the present embodiment, the process of determining the text similarity between the two texts in the non-associated text pair based on the similarities of the respective paths may be implemented in the following manner:
arraying paths of the at least one path in a descending order of sizes of the similarities of the respective paths to obtain a path list; and
determining the similarity of the path at a first order in the path list as the text similarity between the two texts of the non-associated text pair.

Specifically, the similarity of the path with the greatest similarity in the at least one path of the non-associated text pair is taken as the text similarity between the two texts of the non-associated text pair.

Since the weight of the connection edge reflects the text distance between the texts respectively corresponding to the two nodes connected through the connection edge, in the process of calculating the similarity of each path, the path distance of each path is calculated based on the text distances mapped by the connection edges included in each path, and the similarity of each path is determined based on the path distance of each path

For example, the calculation of the text similarity of the non-associated text pair (Text 1, Text 4) in FIG. 3, the process of calculating the text similarity according to the path in the text relation map will be explained in detail. As shown in FIG. 3, the path of this non-associated text pair (Text 1, Text 4) includes:
Path 1: Text 1↔Text 3↔Text 4
Path 2: Text 1↔Text 3↔Text 4
Path 3: Text 1↔Text 3↔Text 4

Where Path 1 includes Text 1, text 3, and Text 4, and a directed connection is established between Text 1 and Text 3, and a directed connection is established between Text 3 and Text 4. The path distance DR1 of Path 1 is expressed by DR1=d13+d34. Then by calculation, the path distance DR2 of Path 2 is expressed by DR2=d15+d54, and the path distance DR3 of Path 3 is expressed by DR3=d12+d25+d54. After obtaining the path distance of each path, the opposite number of the path distance is used as the similarity of each path. Therefore, the similarity of Path 1 is −DR1, the similarity of Path 2 is −DR2, and the similarity of Path 3 is −DR3. The paths are arrayed in the descending order in accordance with the similarity of the path, and the similarity of the arrayed path at the first order is taken as the text similarity of the non-associated text pair (Text 1, Text 4).

The text similarity between the two texts in each non-associated text pair may be calculated based on the above manner, and the text similarity between the two texts in the associated text pair may be calculated in the above manner, that is, Step S206 may be replaced with a step of calculating the text similarity between the two texts in each text pair based on the path between the two nodes corresponding to two of the texts in the text pairs in the text relation map.

In addition to determining the text similarity between the two texts in the non-associated text pair based on the similarity of the path, the text similarity between the two texts in the non-associated text pair may also be determined based on the path distance of the path. Specifically, in an alternative implementation provided by the present embodiment, in a process of determining the text similarity between the two texts in the non-associated text pair in the text relation map according to the path between the two nodes corresponding to two of the texts in the non-associated text pair, the following operations are performed:
determining at least one path between the two nodes corresponding to the two texts in the non-associated text pair based on the text relation map;
calculating a path distance of each of the at least one path based on the weight of the connection edge included in each of the at least one path; and
determining the text similarity between the two texts in the non-associated text pair according to path distances of respective ones of the at least one path.

Alternatively, in the process of determining the text similarity between the two texts in the non-associated text pair according to the path distances of respective ones of the at least one path, paths of the at least one path is arrayed in an ascending order according to the path distances of respective ones of the at least one path to obtain a path list, the path distance of the path at a first-order in the path list is used as the text distance between the two texts of the non-associated text pair, and the text similarity between the two texts of the non-associated text pair is determined based on the text distance between the two texts of the non-associated text pair. Specifically, the negative value of the text distance may be taken as the text similarity.

In addition, the text similarity between the two texts in the associated text pair may be calculated in accordance with a similarity calculation manner corresponding to a first associated text pair and a second associated text pair, respectively by dividing the associated text pair into the first associated text pair and the second associated text pair. In view of this, in an alternative embodiment, the process of constructing the text relation map based on the text set includes:
determining two of the texts with the distance therebetween less than or equal to the distance threshold as a first associated text pair, two of the texts with the distance therebetween greater than the distance threshold and less than or equal to the preset threshold as a second associated text pair, and two of the texts with the distance therebetween greater than the preset threshold as a non-associated text pair; and
determining the text similarity between two of the texts of the first associated text pair based on the distance between the two texts in the first associated text pair; and determining the text similarity between the two texts in the second associated text pair according to a path between two of the nodes corresponding to two of the texts in the second associated text pair in the text relation map.

Alternatively, the first associated text pair is a text pair with a text distance less than the distance threshold value. The second associated text pair is a text pair with a text distance greater than the distance threshold value and less than the preset threshold value.

Specifically, the text similarity between the two texts in the second associated text pair is determined according to a path between the two nodes corresponding to the two texts in the second associated text pair in the text relation map, and the opposite number of the text distance between the two texts in the first associated text pair is used as the text similarity between the two texts in the first associated text pair.

Further, for all associated text pairs, the opposite number of the text distance between the two texts in the associated text pair may be used as the text similarity between the two texts in the associated text pair.

The text similarity of each of the M text pairs is determined in the manner described above, and semantic matching processing is performed based on the text similarity, thereby improving accuracy of the semantic matching processing. Alternatively, after obtaining the text similarity of each text pair, a predetermined number of matching texts matching each text may be determined based on the text similarity of each text pair.

For example, to determine two matching texts that match each text, the matching texts in the two text pairs with the greatest similarity of each text are determined in the text set for each text.

In summary, according to the text processing method provided in the present embodiment, for the M text pairs consisting of every two texts in the N text pairs, the text distance between the two texts in each text pair is first calculated, the initial text similarity is represented by the text distance, then the text pairs are divided into the associated text pair and the non-associated text pair based on the preset threshold value and the text distance between the two texts in each text pair, then the text relation map with directed connections between the two texts in the associated text pair and no connections between the two texts in non-associated text pair is constructed according to the associated text pair and the non-associated text pair, and finally, based on the path between the two texts in the non-associated text pair in the text relation map, the text similarity between the two texts in the non-associated text pair is determined, thereby avoiding an error of the text similarity caused by directly determining the text similarity based on the text distance when the text distance is greater, and improving accuracy of the calculated text similarity between the two texts.

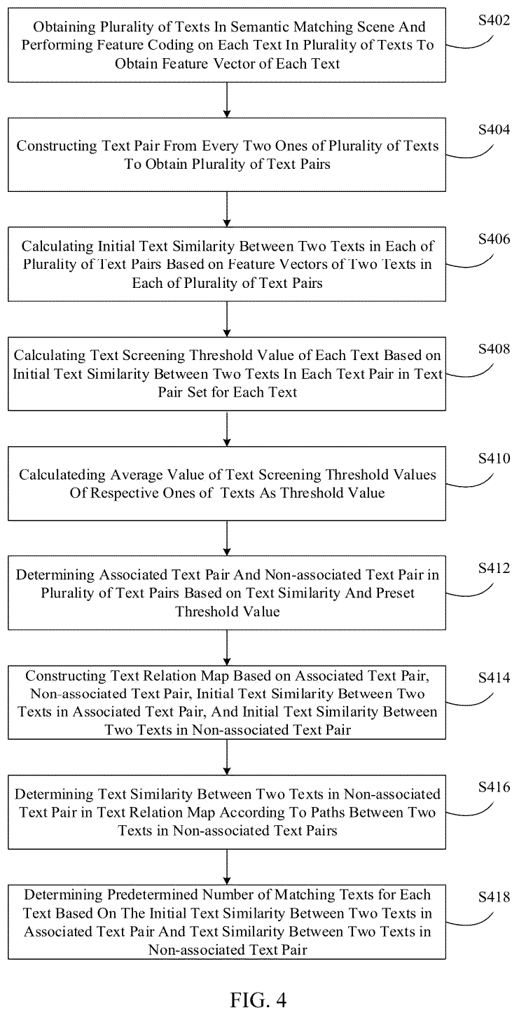

The following further describes a text processing method applied to a semantic matching scene by taking application of the text processing method in the semantic matching scene according to the present embodiment as an example. Referring to FIG. 4, the text processing method applied to the semantic matching scene specifically includes the following steps.

At Step S402, a plurality of texts in a semantic matching scene are obtained and feature coding is performed on each text in the plurality of texts to obtain a feature vector of each text.

At Step S404, a text pair is constructed from every two ones of the plurality of texts to obtain a plurality of text pairs.

At Step S406, an initial text similarity between the two texts in each of the plurality of text pairs is calculated based on the feature vectors of the two texts in each of the plurality of text pairs.

At Step S408, a text screening threshold value of each text is calculated based on the initial text similarity between the two texts in each text pair in a text set for each text.

At Step S410, an average value of the text screening threshold values of respective ones of the texts is calculated as a preset threshold value.

At Step S412, an associated text pair and a non-associated text pair are determined in the plurality of text pairs based on the text similarity and the preset threshold value.

At Step S414, a text relation map is constructed based on the associated text pair, the non-associated text pair, the initial text similarity between the two texts in the associated text pair, and the initial text similarity between the two texts in the non-associated text pair.

At Step S416, a text similarity between the two texts in the non-associated text pair in the text relation map is determined according to paths between the two texts in the non-associated text pairs.

At Step S418, a predetermined number of matching texts for each text may be determined based on the initial text similarity between the two texts in the associated text pair and the text similarity between the two texts in the non-associated text pair.

In addition, in Step S418, a predetermined number of matching texts for the target text in the plurality of texts may further be determined based on the initial text similarity between the two texts in the associated text pair and the text similarity between the two texts in the non-associated text pair. Alternatively, the target text is any one of a plurality of texts.

An embodiment of a text processing apparatus is provided as follows:

In the above-described embodiment, the text processing method is provided, and accordingly, a text processing apparatus is further provided, which will be described below with reference to the accompanying drawings.

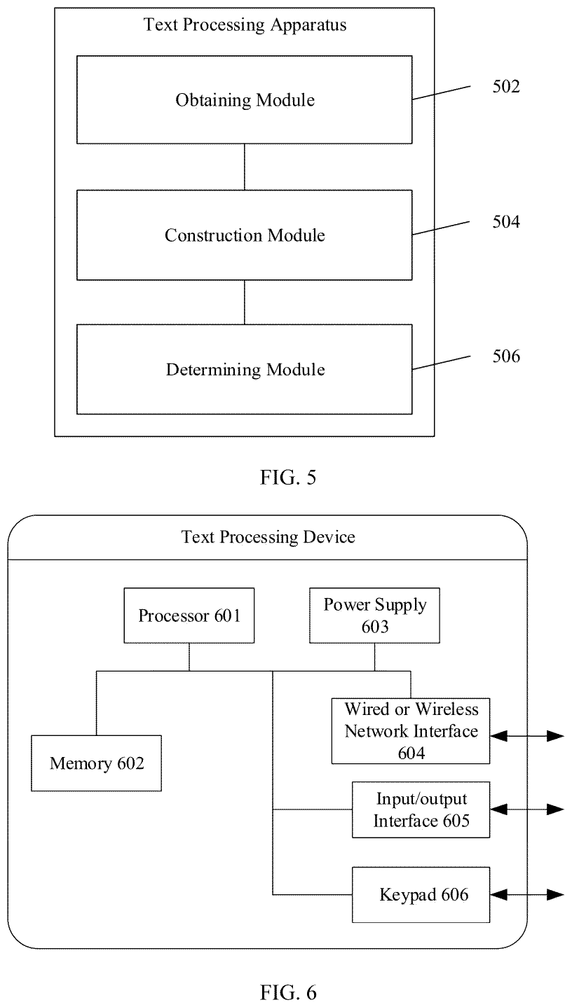

Referring to FIG. 5, FIG. 5 shows a schematic block diagram of a text processing apparatus according to an embodiment of the present application; and Since the device embodiment corresponds to the method embodiment, the description thereof is relatively simple, and the relevant parts may be referred to the corresponding description of the method embodiment provided above. The device embodiment described below are merely illustrative.

The present embodiment provides a text processing apparatus running on a client, including:
an obtaining module 502 configured to obtain N texts and calculate a text distance between every two texts to obtain a text set, where the text set includes M text pairs and the text distance between the two texts of each text pair;
a construction module 504 configured to construct a text relation map based on the text set, where the text relation map includes a text node and a connection edge between the text nodes. The weight of the connection edge reflects the text distance between the texts respectively corresponding to the two text nodes connected through the connection edge; and
a determining module 506 configured to determine a text similarity between the two texts in the non-associated text pair according to a path between the two texts in the non-associated text pair in the text relation map, where the non-associated text pair is a text pair with a text distance greater than a preset threshold value.

In an embodiment, the construction module 504 performs the following steps when constructing the text relation map based on the text set:
determining whether every two ones of texts as associated texts or non-associated texts based on the distance between the two ones of texts and the preset threshold value; and
constructing the text relation map according to the associated texts and the non-associated texts, wherein in the text relation map, wherein the nodes corresponding to two of the texts determined as the associated texts are directionally connected to each other, and the nodes corresponding to two of the texts determined as the non-associated texts pair are not connected.

In an embodiment, the preset threshold value is calculated in the following manner:
determining a text set for each of the N texts, where the text set for each of the N texts consists of the text pairs including each of the N texts;
calculating the text screening threshold value of each of the N texts based on the text set for each of the N texts; and
calculating an average value of the text screening threshold values of respective ones of the texts as the preset threshold value.

In an embodiment, the N texts include the i-th text, and i is an integer less than or equal to N. The text screening threshold value of the i-th text is calculated in the following manner:
arranging the text pairs in the text set for the i-th text in accordance with the text distance between the two texts in each of the text pairs in the text set for the i-th text to obtain a text pair list for the i-th text;
determining a target text pair for the i-th text based on the text distances and the mark distances of the respective text pairs in the text pair list; and
taking the text distance of the target text pair as the text screening threshold value for the i-th text.

In an embodiment, the determining module 506 performs the following operations when determining the text similarity between the two texts in the non-associated text pair in the text relation map according to a path between the non-associated text pairs:
determining at least one path between the two texts in the non-associated text pair based on the text relation map;
calculating a similarity of each of the at least one path based on the weight of the connection edge included in each of the at least one path; and
determining the text similarity between the two texts in the non-associated text pair based on the similarities of respective ones of the at least one path.

In an embodiment, the determining module 506 performs the following operations when determining the text similarity between the two texts in the non-associated text pair based on the similarities of respective ones of the at least one path:
arranging paths of the at least one path in a descending order according to the similarities of the respective paths to obtain a path list; and
taking the similarity of the path at a first order in the path list as the text similarity between the two texts of the non-associated text pair.

In an embodiment, the determining module 506 further performs the operations of:
dividing the M text pairs according to the distance threshold value and the text distance between the two texts in each text pair to obtain the first associated text pair, the second associated text pair, and the non-associated text pair; and
determining the text similarity of the first associated text pair based on the text distance between the two texts in the first associated text pair; and determining the text similarity between the two texts in the second associated text pair according to a path between the second associated text pair in the text relation map.

The first associated text pair is a text pair with a text distance less than the distance threshold value. The second associated text pair is a text pair with a text distance greater than the distance threshold value and less than the preset threshold value.

In an embodiment of the present application, in a process of performing text processing, for N texts, a text distance between every two texts is calculated to obtain a text set including M text pairs and the text distance between the two texts of each text pair. A text relation map formed by a text node and a connection edge for the text nodes is constructed based on the text set. Whereby the text set is obtained by directly calculating the text distance. A text relation map is constructed by the text set, and the text relation map includes a text node and a connecting edge with a weight reflecting a text distance between the texts respectively corresponding to the two nodes connected through the connecting edge, thereby improving a representation effect of a relationship between every two texts in the constructed text relation map. Further, a text similarity between the two texts in the non-associated text pair in the text relation map is determined according to a path between the non-associated text pairs. The text similarity between the two texts in the non-associated text pair in the text relation map is calculated through the path between the non-associated text pairs. While the calculation of the text similarity between every two texts in the non-associated text pair is realized, the accuracy and validity of the calculated text similarity between the two texts in the non-associated text pair are improved.

An embodiment of a text processing apparatus provided in the present specification is as follows: corresponding to the above-described text processing method and based on the same technical concept as the text processing method, an embodiment of the present application further provides a text processing apparatus for performing the above-provided text processing method. FIG. 6 is a schematic block diagram of a text processing device according to an embodiment of the present application.

The text processing device according to an embodiment of the present application includes:

As shown in FIG. 6, the text processing device may vary significantly depending on configuration or performance, and may include one or more processors 601 and a memory 602 in which one or more stored application programs or data may be stored. Among them, the memory 602 may be a temporary storage or a persistent storage. The application program stored in memory 602 may include one or more modules (not shown), each of which may include a series of computer-executable instructions in the text processing device. Further, the processor 601 may be configured to communicate with memory 602 to execute the series of computer-executable instructions in memory 602 on the text processing device. The text processing device may further include one or more power supplies 603, one or more wired or wireless network interfaces 604, one or more input/output interfaces 605, one or more keypads 606, or the like.

In an embodiment, the text processing device includes a memory, and one or more programs. The one or more programs are stored in the memory, and the one or more programs may include one or more modules. Each module may include a series of computer-executable instructions for a text processing device, and configured to execute the one or more programs by one or more processors. The one or more programs includes computer-executable instructions for:
obtaining N texts and calculating a text distance between every two ones of the texts, to obtain a text set, where the text set includes M text pairs and the text distance between the two texts of each text pair;
constructing a text relation map based on the text set, the text relation map includes the text node and the connection edge between the text nodes. The weight of the connection edge reflects a text distance between the texts respectively corresponding to two text nodes connected through the connection edge; and
determining a text similarity between the two texts in the non-associated text pair in the text relation map according to a path between the non-associated text pairs, where the non-associated text pair is a text pair with a text distance greater than a preset threshold value.

In an embodiment, when constructing the text relation map based on the text set, the processor performs the operations of:
determining an associated text pair and a non-associated text pair in the text pairs based on the text distance between every two texts and the preset threshold value; and
constructing the text relation map according to the associated text pair and the non-associated text pair, where in the text relation map, there is a directed connection between the text nodes of the associated text pair, and no connection is established between the text nodes of the non-associated text pair.

In an embodiment, the processor is configured to calculate the preset threshold value by the operations of:
determining a text set for each of the N texts, where the text set for each of the N texts consists of the text pairs including each of the N texts;
calculating the text screening threshold value of each of the N texts based on the text set for each of the N texts; and
calculating an average value of the text screening threshold values of respective ones of the texts as the preset threshold value.

In an embodiment, the N texts include the i-th text, and i is an integer less than or equal to N. The text screening threshold value of the i-th text is calculated by the processor in the following manners:
arranging the text pairs in the text set for the i-th text in accordance with the text distance between the two texts in each of the text pairs in the text set for the i-th text to obtain a text pair list for the i-th text;
determining a target text pair for the i-th text based on the text distances and the mark distances of the respective text pairs in the text pair list; and
taking the text distance of the target text pair as the text screening threshold value for the i-th text.

In an embodiment, when determining the text similarity between the two texts in the non-associated text pair in the text relation map according to a path between the non-associated text pairs, the processor performs the operations of:
determining at least one path between the two texts in the non-associated text pair based on the text relation map;
calculating a similarity of each of the at least one path based on the weight of the connection edge included in each of the at least one path; and
determining the text similarity between the two texts in the non-associated text pair based on the similarities of respective ones of the at least one path.

In an embodiment, when determining the text similarity between the two texts in the non-associated text pair based on the similarities of respective ones of the at least one path, the processor performs the operations of:
arranging paths of the at least one path in a descending order according to the similarities of the respective paths to obtain a path list; and
taking the similarity of the path at a first order in the path list as the text similarity between the two texts of the non-associated text pair.

In an embodiment, the processor further performs the operations of:
dividing the M text pairs according to the distance threshold value and the text distance between the two texts in each text pair to obtain the first associated text pair, the second associated text pair, and the non-associated text pair; and
determining the text similarity of the first associated text pair based on the text distance between the two texts in the first associated text pair; and determining the text similarity between the two texts in the second associated text pair according to a path between the second associated text pair in the text relation map.

The first associated text pair is a text pair with a text distance less than the distance threshold value. The second associated text pair is a text pair with a text distance greater than the distance threshold value and less than the preset threshold value.

In an embodiment of the present application, in a process of performing text processing, for N texts, a text distance between every two texts is calculated to obtain a text set including M text pairs and the text distance between the two texts of each text pair. A text relation map formed by a text node and a connection edge for the text nodes is constructed based on the text set. Whereby the text set is obtained by directly calculating the text distance. A text relation map is constructed by the text set, and the text relation map includes a text node and a connecting edge with a weight reflecting a text distance between the texts respectively corresponding to the two nodes connected through the connecting edge, thereby improving a representation effect of a relationship between every two texts in the constructed text relation map. Further, text similarity between the two texts in the non-associated text pair in the text relation map is determined according to a path between the non-associated text pairs. The text similarity between the two texts in the non-associated text pair in the text relation map is calculated through the path between the non-associated text pairs. While the calculation of the text similarity between every two texts in the non-associated text pair is realized, the accuracy and validity of the calculated text similarity between the two texts in the non-associated text pair are improved.

An embodiment of a computer readable storage medium is provided in the present application.

According to the text processing method described above, based on the same technical concept, an embodiment of the present application further provides a computer readable storage medium.

The present embodiment provides a computer-readable storage medium for storing computer-executable instructions that, when executed by a processor, implement the following operations:
obtaining N texts and calculating a text distance between every two ones of the texts, to obtain a text set, where the text set includes M text pairs and the text distance between the two texts of each text pair;
constructing a text relation map based on the text set, the text relation map includes the text node and the connection edge between the text nodes. The weight of the connection edge reflects a text distance between the texts respectively corresponding to two text nodes connected through the connection edge; and
determining text similarity between the two texts in the non-associated text pair in the text relation map according to a path between the non-associated text pairs, where the non-associated text pair is a text pair with a text distance greater than a preset threshold value.

It should be noted that an embodiment of the present specification with respect to the computer readable storage medium has the same inventive concept as an embodiment of the present specification with respect to the text processing method. Therefore, for a specific implementation of the present embodiment, reference may be made to the implementation of the foregoing corresponding method, and details are not repeated.

Specific embodiments of this specification have been described above. Other embodiments obtained from the specific embodiments are within the scope of the appended claims. In some cases, the steps or operations recited in the claims may be performed in an order different from that in the embodiments and the desired results may still be achieved. In addition, the processes depicted in the drawings do not necessarily require the particular order or sequential order shown in the drawings to achieve the desired results. In certain embodiments, multitasking and parallel processing are also possible or may be advantageous.

It will be appreciated by those skilled in the art that embodiments of the present application may be provided as a method, system, or computer program product. Thus, embodiments of the present application may be provided in the form of a full hardware embodiment, a full software embodiment, or an embodiment combining software and hardware aspects. Moreover, the present specification may take the form of a computer program product embodied on one or more computer readable storage media (including but not limited to, magnetic disk memory, CD-ROM, optical memory, or the like) having computer usable program code embodied therein.

The specification is described with reference to flowcharts and/or block diagrams of methods, devices (systems), and computer program products according to embodiments of the specification. It is to be understood that each flow and/or block in the flowcharts and/or block diagrams, and combinations of the flow and/or the block in the flowcharts and/or block diagrams may be implemented by computer program instructions. These computer program instructions may be provided to a processor of a general purpose computer, special purpose computer, embedded processor, or other programmable testing device to generate a machine, such that the instructions executed by the processor of the computer or other programmable testing device are used to realize means for implementing the functions specified in one or more flows of the flowchart and/or one or more blocks of the block diagrams.

These computer program instructions may further be stored in the computer-readable memory capable of directing a computer or other programmable testing device to operate in a particular manner, such that the instructions stored in the computer-readable memory generate an article of manufacture including instruction means that perform the functions specified in one or more flows of the flowchart and/or one or more blocks of the block diagrams.

These computer program instructions may further be loaded onto a computer or other programmable testing device such that a series of operational steps are performed on the computer or other programmable device to produce a computer-implemented process, such that the instructions that execute on the computer or other programmable device provide steps for implementing the functions specified in one or more flows of the flowchart and/or one or more blocks of the block diagrams

In a typical configuration, a computing device includes one or more processors (CPUs), input/output interfaces, network interfaces, and memory.

The memory may include non-permanent memory in the computer-readable medium, random access memory (RAM), and/or non-volatile memory, such as read only memory (ROM) or flash memory (flash RAM). The memory is an example of a computer-readable medium.

Computer-readable media, including permanent and non-permanent, removable and non-removable media, may implement information storage by any method or technique. The information may be computer readable instructions, data structures, modules of a program, or other data. Examples of storage media for the computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only optical disk read-only memory (CD-ROM), digital versatile disks (DVD) or other optical storage, magnetic cassette tape, magnetic disk storage or other magnetic storage devices, or any other non-transmission medium that may be used to store information that may be accessed by the computing device. As defined herein, the computer-readable medium does not include a transitory media, such as a modulated data signal and a carrier wave.

It is also noted that the terms “comprise” “include”, or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element defined by the phrase “include a . . . ” does not exclude the existence of another identical element in the process, method, article, or device comprising said element.

An Embodiment of the present application may be described in the general context of computer-executable instructions executed by the computer, such as program modules. Generally, the program modules include routines, programs, objects, components, data structures, etc. that perform particular tasks or implement particular abstract data types. One or more embodiments of the present specification may further be practiced in distributed computing environments in which tasks are performed by remote processing devices connected through a communication network. In a distributed computing environment, the program modules may be located in local and remote computer storage media, including storage devices.

The various embodiments in this specification have been described in a progressive manner, and reference may be made to each other for the same and similar parts among the various embodiments, each of which focuses on differences from other embodiments. With respect to the system embodiment, since it is substantially similar to the method embodiment, the description thereof is relatively simple, and reference may be made to a part of the description of the method embodiment.

The foregoing description is merely an example of the present application and is not intended to limit the present application. Various modifications and variations of the present application are possible for those skilled in the art. Any modifications, equivalents, improvements, or the like, within the spirit and principles of the present application, are intended to fall within the scope of the present application.

What is claimed is:

1. A text processing method, comprising:
calculating a distance between every two ones of texts, to obtain a text set, wherein the text set comprises every two ones of texts and the distance between every two ones of texts;
constructing a text relation map based on the text set, wherein the text relation map comprises nodes and connection edges, each of the nodes corresponds to a corresponding one of the texts, at least two ones of the nodes are connected via the connection edge, and a weight of each of the connection edges corresponds to the distance between two of the texts corresponding to two of the nodes connected through the connected edge; and
in response to the distance between two ones of the texts greater than a preset threshold value, determining a text similarity between the two ones of the texts according to a path between two of the nodes corresponding to the two ones of the texts, wherein the path comprises at least two of the connected edges.

2. The text processing method of claim 1, wherein the constructing of the text relation map based on the text set comprises:
determining whether every two ones of texts as associated texts or non-associated texts based on the distance between the two ones of texts and the preset threshold value; and
constructing the text relation map according to the associated texts and the non-associated texts, wherein in the text relation map, wherein the nodes corresponding to two of the texts determined as the associated texts are directionally connected to each other, and the nodes corresponding to two of the texts determined as the non-associated texts pair are not connected.

3. The text processing method of claim 1, further comprising: before determining the text similarity between the two ones of the texts according to the path between two of the nodes corresponding to the two ones of the texts,
determining a sub text set for each of the texts, wherein the sub text set comprises text pairs each comprising the text;
calculating a text screening threshold value of each of the texts based on the sub text set for the text, to obtain the text screening threshold values of respective ones of the texts; and
calculating an average value of the text screening threshold values of respective ones of the texts as the preset threshold value.

4. The text processing method of claim 3, wherein the calculating of the text screening threshold value of each of the texts based on the sub text set for the text comprises: for each of the texts,
performing distance representation on two texts in each of the text pairs in the sub text set by using a Euclidean distance method, to obtain distances respectively for the text pairs in the sub text set;
arraying the text pairs in the sub text set in a first order based on a size of the distance for the two texts in each of the text pairs in the sub text set to obtain a text pair list for the text; and
identifying, as a target text pair, a text pair in the text pair list with an actual similarity ordered in the first order relative to an actual similarity of another text pair in the text pair list after the text pair, and determining a distance of the target text pair as the text screening threshold value for the text.

5. The text processing method of claim 1, wherein the determining of the text similarity between the two texts in the texts according to the path between two of the nodes corresponding to the two ones of the texts in response to the distance between the two ones of the texts greater than the preset threshold value comprises:
determining at least one path between two of the nodes corresponding to the two texts based on the text relation map;
calculating a sum of the weights of the connection edges comprised in each of the at least one path as a similarity of each of the at least one path, to obtain similarities of respective ones of the at least one path; and
determining the text similarity between the two texts based on the similarities of respective ones of the at least one path.

6. The text processing method of claim 5, wherein the determining of the text similarity between the two texts based on the similarities of respective ones of the at least one path comprises:
arraying the at least one path in a descending order of sizes of the similarities of respective ones of the at least one path to obtain a path list; and
determining the similarity of one of the at least one path at a first order of the path list as the text similarity between the two texts.

7. The text processing method of claim 1, further comprising: after constructing the text relation map based on the text set,
determining two of the texts with the distance therebetween less than or equal to the distance threshold as a first associated text pair, two of the texts with the distance therebetween greater than the distance threshold and less than or equal to the preset threshold as a second associated text pair, and two of the texts with the distance therebetween greater than the preset threshold as a non-associated text pair; and
determining a text similarity between two of the texts in the first associated text pair according to the distance between two of the texts in the first associated text pair; and determining a text similarity between two of the texts in the second associated text pair according to a path between two of the nodes corresponding to two of the texts in the second associated text pair in the text relation map, wherein the path corresponding to the second associated text pair comprises at least two connecting edges.

8. A text processing apparatus, comprising:
an obtaining module configured to calculate a distance between every two ones of texts, to obtain a text set, wherein the text set comprises every two ones of texts and the distance between every two ones of texts;
a construction module configured to construct a text relation map based on the text set, wherein the text relation map comprises nodes and connection edges, each of the nodes corresponds to a corresponding one of the texts, at least two ones of the nodes are connected via the connection edge, and a weight of each of the connection edges corresponds to the distance between two of the texts corresponding to two of the nodes connected through the connected edge; and
a determining module configured to determine a text similarity between the two ones of the texts according to a path between two of the nodes corresponding to the two ones of the texts, in response to the distance between two ones of the texts greater than a preset threshold value, wherein the path comprises at least two of the connected edges.

9. A text processing device, comprising:
a processor and a memory configured to store a computer-executable instruction that, when executed, makes the processor perform the text processing method of claim 1.

10. The text processing device of claim 9, wherein the constructing of the text relation map based on the text set comprises:
determining whether every two ones of texts as associated texts or non-associated texts based on the distance between the two ones of texts and the preset threshold value; and
constructing the text relation map according to the associated texts and the non-associated texts, wherein in the text relation map, wherein the nodes corresponding to two of the texts determined as the associated texts are directionally connected to each other, and the nodes corresponding to two of the texts determined as the non-associated texts pair are not connected.

11. The text processing device of claim 9, wherein the text processing method further comprises: before determining the text similarity between the two ones of the texts according to the path between two of the nodes corresponding to the two ones of the texts,
determining a sub text set for each of the texts, wherein the sub text set comprises text pairs each comprising the text;
calculating a text screening threshold value of each of the texts based on the sub text set for the text, to obtain the text screening threshold values of respective ones of the texts; and
calculating an average value of the text screening threshold values of respective ones of the texts as the preset threshold value.

12. The text processing device of claim 11, wherein the calculating of the text screening threshold value of each of the texts based on the sub text set comprises: for each of the texts,
performing distance representation on two texts in each of the text pairs in the sub text set by using a Euclidean distance method, to obtain distances respectively for the text pairs in the sub text set;
arraying the text pairs in the sub text set in a first order based on a size of the distance for the two texts in each of the text pairs in the sub text set to obtain a text pair list for the text; and
identifying, as a target text pair, a text pair in the text pair list with an actual similarity ordered in the first order relative to an actual similarity of another text pair in the text pair list after the text pair, and determining a distance of the target text pair as the text screening threshold value for the text.

13. The text processing device of claim 9, wherein the determining of the text similarity between the two texts in the texts according to the path between two of the nodes corresponding to the two ones of the texts in response to the distance between the two ones of the texts greater than the preset threshold value comprises:
determining at least one path between two of the nodes corresponding to the two texts based on the text relation map;
calculating a sum of the weights of the connection edges comprised in each of the at least one path as a similarity of each of the at least one path, to obtain similarities of respective ones of the at least one path; and
determining the text similarity between the two texts based on the similarities of respective ones of the at least one path.

14. The text processing device of claim 13, wherein the determining of the text similarity between the two texts based on the similarities of respective ones of the at least one path comprises:
arraying the at least one path in a descending order of sizes of the similarities of respective ones of the at least one path to obtain a path list; and
determining the similarity of one of the at least one path at a first order of the path list as the text similarity between the two texts.

15. A non-transitory computer-readable storage medium, wherein the non-transitory computer-readable storage medium is configured to store a computer-executable instruction, and when executed by a processor, the computer-executable instructions implement the text processing method of claim 1.

16. The non-transitory computer-readable storage medium of claim 15, wherein the constructing of the text relation map based on the text set comprises:
determining whether every two ones of texts as associated texts or non-associated texts based on the distance between the two ones of texts and the preset threshold value; and
constructing the text relation map according to the associated texts and the non-associated texts, wherein in the text relation map, wherein the nodes corresponding to two of the texts determined as the associated texts are directionally connected to each other, and the nodes corresponding to two of the texts determined as the non-associated texts pair are not connected.

17. The non-transitory computer-readable storage medium of claim 15, wherein the text processing method further comprises: before determining the text similarity between the two ones of the texts according to the path between two of the nodes corresponding to the two ones of the texts,
determining a sub text set for each of the texts, wherein the sub text set comprises text pairs each comprising the text;
calculating a text screening threshold value of each of the texts based on the sub text set for the text, to obtain the text screening threshold values of respective ones of the texts; and
calculating an average value of the text screening threshold values of respective ones of the texts as the preset threshold value.

18. The non-transitory computer-readable storage medium of claim 17, wherein the calculating of the text screening threshold value of each of the texts based on the sub text set for the text comprises: for each of the texts,
performing distance representation on two texts in each of the text pairs in the sub text set by using a Euclidean distance method, to obtain distances respectively for the text pairs in the sub text set;
arraying the text pairs in the sub text set in a first order based on a size of the distance for the two texts in each of the text pairs in the sub text set to obtain a text pair list for the text; and
identifying, as a target text pair, a text pair in the text pair list with an actual similarity ordered in the first order relative to an actual similarity of another text pair in the text pair list after the text pair, and determining a distance of the target text pair as the text screening threshold value for the text.

19. The non-transitory computer-readable storage medium of claim 15, wherein the determining of the text similarity between the two texts in the texts according to the path between two of the nodes corresponding to the two ones of the texts in response to the distance between the two ones of the texts greater than the preset threshold value comprises:
determining at least one path between two of the nodes corresponding to the two texts based on the text relation map;
calculating a sum of the weights of the connection edges comprised in each of the at least one path as a similarity of each of the at least one path, to obtain similarities of respective ones of the at least one path; and
determining the text similarity between the two texts based on the similarities of respective ones of the at least one path.

20. The non-transitory computer-readable storage medium of claim 19, wherein the determining of the text similarity between the two texts based on the similarities of respective ones of the at least one path comprises:
arraying the at least one path in a descending order of sizes of the similarities of respective ones of the at least one path to obtain a path list; and
determining the similarity of one of the at least one path at a first order of the path list as the text similarity between the two texts.
